(19) United States
(12) Patent Application Publication
(10) Pub. No.: US 2021/0404235 A1
(43) Pub. Date: Dec. 30, 2021

(54) Foot Operated Door Opener

(71) Applicant: Ryan Hamamoto, Changhua County (TW)

(72) Inventor: Ryan Hamamoto, Changhua County (TW)

(21) Appl. No.: 16/926,849

(22) Filed: Jul. 13, 2020

(30) Foreign Application Priority Data
Jun. 30, 2020 (TW) 109208265

(51) Int. Cl. E05F 11/54

(52) U.S. Cl. CPC E05F 11/54; E05Y 2201/676; E05Y 2600/13; E05Y 2201/46

(57) ABSTRACT

A foot operated door opener comprises a front panel, a rear panel and an anti-slippery structure formed on the front panel. The front panel and the rear panel are connected and pivotally rotated through a hollow connecting tube of the front panel and two fixing tubes of the real panel. The present invention provides user's foot enough tension or fiction to easily flip or rotate the front panel from the rear panel in a folded or unfolded condition and push or pull the door along with the foot. The door will be hence opened simply by user's foot without their hands touching it. This could benefit the user with both hands holding and carrying stuffs and also could prevent germs or bacterial infection by not touching the door.

### FIELD OF INVENTION

Present invention is related to a building field assisting people in gaining ingress and egress from buildings more efficiently without need for the use of hands touching the door or handle. This invention is directed, and more particularly, toward adding a mechanical device or component for ease of operation to a person's effort in opening doors.

The foot operated door opener of the present invention is useful with different types of doors. It is particularly useful for opening a sliding door so that user's hands are free to hold objects or to provide a more sanitary way to open the door by reducing chances of touching the door. However, it will be appreciated that this invention is not limited to this particular field of use. Any reasonable alternation or substation shall not fail to fall within a protected scope of this invention.

### BACKGROUND OF THE INVENTION

Hand operated doors usually have door handles, knobs or hand pulls for grasping by hand to open the door. Although these components or devices seem easily to be operated, they are still quite inconvenient and frustrated for the user with both hands occupied with objects. Except calling for help from somebody nearby, the users need to put down all the holding objects to be able to open the door. This will waste a lot of time and cause a lot of troublesome to just simply open a door.

The other concern is unsanitary issue of these hand operated doors, especially the doors in public area. Their door knobs, handles or hand pulls are normally in unsanitary conditions due to contamination by many harmful bacteria and germs from outside environment and continuously touching by people. These devices are considered a perfect bed and vehicle for breeding and transmitting harmful substances to people by hand contact and causing a risk of spreading illness or disease. Especially during the outbreak of serious pandemic, it is very important and to be careful not to touch or contact any surface in the public area to avoid germs or bacterial infection.

Hence, it is eager to have a novel door opener that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve shortcomings of conventional door knob, handles or hand pulls which are not easily to be operated if both hands are occupied with objects or to avoid touching or contacting unsanitary doors, the present invention is provided for enable users to open the door by foot. The present invention cleverly uses folding structure that can be easily operated by foot for solving abovementioned problems and shortcomings of the conventional hand operated door.

According to a preferred aspect of the present invention, a door opener, which could be operated by foot, comprises a front panel and a rear panel. The front panel comprises a distal end and a proximal end. An anti-slippery structure is formed on the front panel. The anti-slippery structure comprises a friction surface or a structure facing up at an angle or protruded from a plane surface of the front panel. A hollow connecting tube is connected on an edge of the proximal end of the front panel. The rear panel also comprises a distal end and a proximal end. A rectangle gap is provided at a middle of an edge of the proximal end of the rear panel. Two fixing tubes formed at right and left side of the rectangle gap on the edge of the proximal end of the rear panel. The front panel and the rear panel are connected and pivotally rotated through connecting the hollow connecting tube of the front panel and the two fixing tubes of the real panel.

In accordance, the present invention has the following advantages.

By designing the anti-slippery structures on the present invention, these structures could provide user's foot enough tension or fiction to easily flip or rotate the front panel from the rear panel in a folded or unfolded condition and push or pull the door along with the foot. The door will be hence opened simply by user's foot without their hands touching it. This could benefit the user with both hands holding and carrying stuffs and also could prevent germs or bacterial infection by not touching the door.

The present invention on the other hand could also help those with weakened upper muscles, bone and joint problems, such as disable or arthritis. They can operate the present invention by foot through use of the weight from whole body without using hands and add mechanical advantage to the amount of force applied to the opener.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a perspective view of a preferred embodiment of the foot operated door opener in folded condition in accordance with the present invention;

FIG. 2 is a perspective view of a preferred embodiment of the foot operated door opener in unfolded condition in accordance with the present invention;

FIG. 3 is a exploded view of a preferred embodiment of the foot operated door opener in accordance with the present invention; and

FIG. 4 is an illustration of using the foot operated door opener in accordance with the present invention.

### DETAILED DESCRIPTION OF THE PREFERRED EMBODIMENTS

In order to make purposes, technical solutions, and advantages of the present invention to be clearer, the following content provides some preferred embodiments in accordance with the present invention.

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean “including but not limited to”.

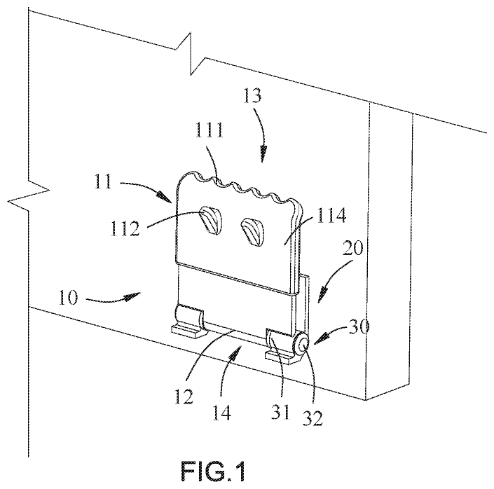

With reference to FIGS. 1 to 3, one preferred embodiment of the present invention is provided in a perspective view in folded and unfolded conditions and an exploded view for better understanding of structure designs of the present invention. In this preferred embodiment, the foot operated door opener comprises a front panel 10, a rear panel 20 and a pivot section 30 and a magnet component 40. The front panel 10 is preferred to be a metal panel or film in this embodiment providing a better durability of using. The front panel 10 comprises a distal end 13 and a proximal end 14. Multiple anti-slippery structures 11 are formed on the distal end 13 of the front panel 10. A hollow connecting tube 12 is formed or connected on an edge of the proximal end 14 of the front panel 10 extending from left to right with its length shorter than a length of the edge of the proximal end 14. In this embodiment, the front panel 10 could be produced by a conventional metal stamping process to obtain a one piece structure.

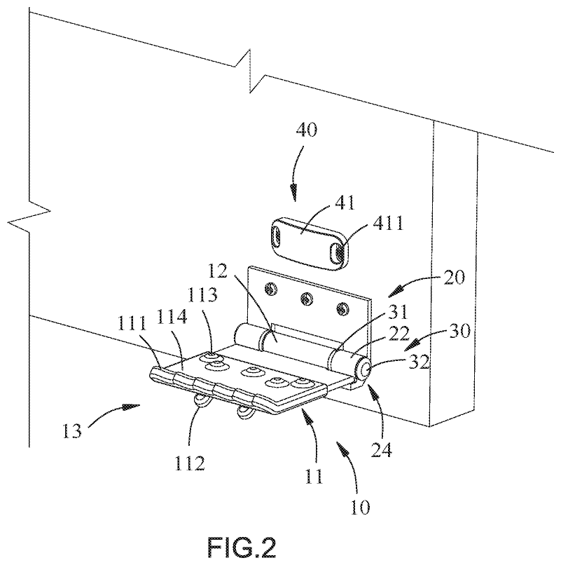

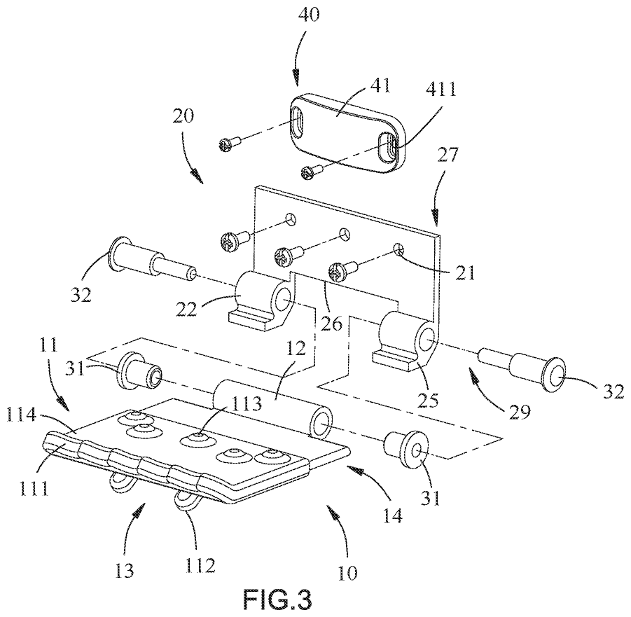

The aforementioned anti-slippery structures 11 could be formed on or protruded from a surface of the front panel 10. For example, the anti-slippery structures 11 comprise an anti-slippery coating surface 114 with multiple clawlike extrusions 111, 112 and at least one protrusions 113 formed thereon. With reference to FIGS. 2 and 3, several clawlike extrusions 111 are formed at an edge of the distal end 13 of the front panel 10. Preferably, the clawlike extrusions 111 are bended at an angle from a plane surface of the front panel 10. Two clawlike extrusions 112 in this embodiment are formed at an outer surface of the front panel 10. With reference to FIG. 2, it is preferred that tips of all the clawlike extrusions 111 and 112 are facing up at an angle from the plane surface of the front panel 10. Another preferred embodiment for the clawlike extrusions 111 and 112 in the present invention could also be a one or several continuous filmed-like structures facing up at certain angle from the plane surface of the front panel 10. The at least one protrusions 113 or five protrusions 113 shown in figures are formed at an inner surface of the front panel 10 facing toward the rear panel 20 in folded condition of the present invention. These protrusions 113 could be but not limited to any desirable shapes for increasing friction, such as protruded wavy lines or bumps. The anti-slippery structures 11 in the present invention provide friction and allow user to step on the front panel 10 more easily and securely without slippery from it.

With reference to FIGS. 2 and 3, the rear panel 20 in this embodiment is a metal film also comprising a distal end 27 and a proximal end 29. Several apertures 21 are provided near an edge of the proximal end 29 of the rear panel 20 for fixing the rear panel 20 on any surface with fixing elements, like screws shown in FIG. 3. A number of the apertures 21 are not limited in this present invention. The number of the apertures 21 could be three shown in FIG. 3 in this preferred embodiment. A rectangle gap 26 is provided at a middle of an edge of the proximal end 29 of the rear panel 20. A length of the rectangle gap 26 is shorter than a length of the edge of the proximal end 29. Further provided are two fixing tubes 22 formed at right and left side of the rectangle gap 26 on the edge of the proximal end 29 of the rear panel 20. Two curved films 25 are formed at the proximal end 29 of the rear panel 20 extending underneath the two fixing tube 22 correspondingly with its tips slightly protruded from the two fixing tube 22 as shown in FIG. 2. The two curved films 25 are preferred at an angel of 90 degree or close to 90 degree extending from a plane surface of the rear panel 20 in this embodiment.

When assembly the front panel 10 and the rear panel 20 of the present invention, these two pieces are connected by its proximal end 14 and 29 at the pivot section 30. As shown in FIGS. 2 and 3, the hollow connecting tube 12 of the front panel 10 is inserted into the rectangle gap 26 between the two fixing tubes 22 of the rear panel 20. Two connecting pins 32 are inserted from outside of the two fixing tubes 22 through its inner tunnel and reach an inner tunnel of the hollow connecting tube 12. The front panel 10 and the rear panel 20 hence could be pivoted through the pivot section 30 with connected hollow connecting tube 12 and two fixing tubes 22 by the two connecting pins 32. The front panel 10 and the rear panel 20 are able to be in a folded condition shown in FIG. 1 and unfolded condition shown in FIG. 2. Preferably, a diameter of the hollow connecting tube 12 of the front panel 10 is equal to or approximate to a diameter of the two fixing tubes 22 of the rear panel 20 for better assembly and appearance. Two lining tubes 31 could be further utilized by inserting into the inner tunnel of the hollow connecting tube 12. The lining tube 31 is able to reduce an inner diameter of the inner tunnel of the hollow connecting tube 12 given the two connecting pins 32 a more secure connection between the hollow connecting tube 12 and the hollow connecting tube 12. When the present invention is in unfolded condition as shown in FIG. 2, the two curved films 25 will block the front panel 10 to be flipped over 90 degree.

In another preferred embodiment, the magnet component 40 could be further utilized accompanying with the foot operated door opener provided by the present invention. As shown in FIGS. 2 to 4, the magnet component 40 comprises a case 41 with magnet put inside the case 41. Several pores 411 are provided on the case 41 for securing the magnet component 40 by the screws. The magnet component 40 is preferable to be fixed at a same surface of fixing the rear panel 20 and within an area covered by the front panel 10 when in the folded condition of the present invention. As the front panel 10 is a metal film or preferably a magnet attractive material, the front panel 10 is able to be attracted and remaining attached to the magnet component 40 in folded condition.

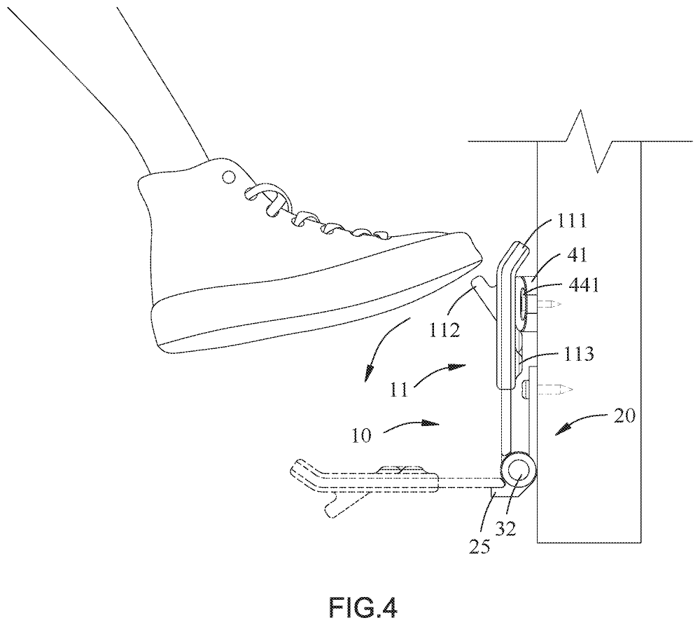

With reference to FIG. 4, the foot operated door opener provided by the present invention is fixed on a door by screwing the rear panel 20 on the door surface, preferably at a bottom of the door panel near ground. As the foot operated door opener is in folded condition, a user's foot could firstly step on the clawlike extrusions 112 at outer surface of the front panel 10 and flip down the front panel 10 to be in the unfolded condition. Further, the user's foot could step on the clawlike extrusions 111 and the protrusions 113 to push or pull the door open or close. These clawlike extrusions 111 and the protrusions 113 could create enough tension toward the user's foot and make the door moving along with the user's foot. Also, the structure design of the present invention is of sufficient strength to open all types of doors, including heavy doors. Users no longer need to touch the door by hand which could reduce the chance of infection by the germs or bacteria attached on the door.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A door opener comprising a front panel and a rear panel, wherein:
the front panel comprises a distal end and a proximal end, wherein:
an anti-slippery structure is formed on the front panel;
the anti-slippery structure is a friction surface or a structure facing up at an angle or protruded from a plane surface of the front panel;
a hollow connecting tube is connected on an edge of the proximal end of the front panel;
the rear panel comprises a distal end and a proximal end, wherein:
a rectangle gap is provided at a middle of an edge of the proximal end of the rear panel;
two fixing tubes formed at right and left side of the rectangle gap on the edge of the proximal end of the rear panel;
the front panel and the rear panel are connected and pivotally rotated through connecting the hollow connecting tube of the front panel and the two fixing tubes of the real panel.

2. The door opener as claimed in claim 1, wherein: the anti-slippery structure comprises multiple clawlike or filmlike extrusions formed on the distal end of the front panel or an outer surface of the front panel.

3. The door opener as claimed in claim 1, wherein: the anti-slippery structure comprises at least one protrusions formed on an inner surface of the front panel.

4. The door opener as claimed in claim 2, wherein: the anti-slippery structure comprises at least one protrusions formed on an inner surface of the front panel.

5. The door opener as claimed in claim 1, wherein: an aperture is provided near an edge of the proximal end of the rear panel.

6. The door opener as claimed in claim 2, wherein: an aperture is provided near an edge of the proximal end of the rear panel.

7. The door opener as claimed in claim 3, wherein: an aperture is provided near an edge of the proximal end of the rear panel.

8. The door opener as claimed in claim 4, wherein: an aperture is provided near an edge of the proximal end of the rear panel.

9. The door opener as claimed in claim 1, wherein: two curved films are formed at the proximal end of the rear panel extending underneath the two fixing tube correspondingly with its tips protruded from the two fixing tube.

10. The door opener as claimed in claim 2, wherein: two curved films are formed at the proximal end of the rear panel extending underneath the two fixing tube correspondingly with its tips protruded from the two fixing tube.

11. The door opener as claimed in claim 3, wherein: two curved films are formed at the proximal end of the rear panel extending underneath the two fixing tube correspondingly with its tips protruded from the two fixing tube.

12. The door opener as claimed in claim 4, wherein: two curved films are formed at the proximal end of the rear panel extending underneath the two fixing tube correspondingly with its tips protruded from the two fixing tube.

13. The door opener as claimed in claim 9, wherein: the two curved films are at an angel of 90 degree or close to 90 degree extending from a plane surface of the rear panel.

14. The door opener as claimed in claim 10, wherein: the two curved films are at an angel of 90 degree or close to 90 degree extending from a plane surface of the rear panel.

15. The door opener as claimed in claim 11, wherein: the two curved films are at an angel of 90 degree or close to 90 degree extending from a plane surface of the rear panel.

16. The door opener as claimed in claim 12, wherein: the two curved films are at an angel of 90 degree or close to 90 degree extending from a plane surface of the rear panel.

17. The door opener as claimed in claim 1, wherein:
the front panel and the rear panel are connected by its proximal end respectively;
the hollow connecting tube of the front panel is inserted into the rectangle gap between the two fixing tubes of the rear panel; and
two connecting pins are inserted from outside of the two fixing tubes through its inner tunnel and reach an inner tunnel of the hollow connecting tube.

18. The door opener as claimed in claim 17, wherein: two lining tubes are inserted into the inner tunnel of the hollow connecting tube.

19. The door opener as claimed in claim 1, wherein:
a magnet component is further provided adjacent to the rear panel at same surface within an area covered by the front panel; wherein:
the magnet component comprises a case with magnet put inside the case;
the case comprises pores; and
the front panel comprise metal or magnet attractive material.
